(19) United States
(12) Patent Application Publication
(10) Pub. No.: US 2026/0162377 A1
(43) Pub. Date: Jun. 11, 2026

(54) VISUAL ASSIGNMENT OF FIRST RESPONDER ZONES

(71) Applicant: AT&T Intellectual Property I, L.P., Atlanta, GA (US)

(72) Inventors: James H. Pratt, Round Rock, TX (US); Inderpreet Singh Ahluwalia, Austin, TX (US); Gregory W. Edwards, Austin, TX (US); Eric Zavesky, Austin, TX (US)

(73) Assignee: AT&T Intellectual Property I, L.P., Atlanta, GA (US)

(21) Appl. No.: 18/970,215

(22) Filed: Dec. 5, 2024

(51) Int. Cl. G06T 19/00; G01S 17/89

(52) U.S. Cl. CPC G06T 19/006; G01S 17/89

(57) ABSTRACT

Aspects of the subject disclosure may include, for example, receiving data of a first visual representation from a first source, the first source configured to produce the first visual representation, receiving an indication of a zone of coordinates comprising at least a portion of the first visual representation, storing information about the zone of coordinates, identifying a second source configured to produce a second visual representation, wherein the second visual representation includes at least a portion of the zone of coordinates, and managing events within the zone of coordinates based on the first visual representation and the second visual representation. Other embodiments are disclosed.

### FIELD OF THE DISCLOSURE

The subject disclosure relates to a system and method permitting a user to define and manage a geographic area, particularly when the user is located remotely from the area.

### BACKGROUND

A problem exists in that users do not currently have a convenient means by which to define and manage areas, particularly when they are not present at the location. This is necessary for the user to be able to properly manage areas for which they are responsible.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating a first example, non-limiting embodiment of a system functioning within the communication network of FIG. 1 in accordance with various aspects described herein.

FIG. 2B is a block diagram illustrating a second example, non-limiting embodiment of a system functioning within the communication network of FIG. 1 in accordance with various aspects described herein.

FIG. 2C is a block diagram illustrating a second example, non-limiting embodiment of a system functioning within the communication network of FIG. 1 in accordance with various aspects described herein.

FIG. 2D is an example of operation of the system of FIG. 2C.

FIG. 2E is an example of operation of the system of FIG. 2C.

FIG. 2F is an example of operation of a system in accordance with various aspects described herein.

FIG. 2G is an example of operation of a system in accordance with various aspects described herein.

FIG. 2H depicts an illustrative embodiment of a method in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for enabling the definition, monitoring, and management of 3D virtual zones for first responders and other users using a networked system of cameras with LiDAR capabilities, an edge server, and databases for storing camera and zone information. The system facilitates real-time communication and augmented reality displays to enhance situational awareness and coordination for users including first responders. It can be adapted for various applications, including facility management, event security, and smart city infrastructure. Other embodiments are described in the subject disclosure.

One or more aspects of the subject disclosure include receiving data of a first visual representation from a first source, the first source configured to produce the first visual representation, receiving an indication of a zone of coordinates comprising at least a portion of the first visual representation, storing information about the zone of coordinates, identifying a second source configured to produce a second visual representation, wherein the second visual representation includes at least a portion of the zone of coordinates, and managing events within the zone of coordinates based on the first visual representation and the second visual representation.

One or more aspects of the subject disclosure include receiving a first video feed from a first camera, the first video feed showing a view of an environment including the first camera, receiving a zone of coordinates corresponding to a first field of view of the first camera, identifying a second camera having a second field of view corresponding at least in part to the first field of view of the first camera, wherein the identifying the second camera is based on the zone of coordinates, and providing information to first responder personnel located in or near an area including the environment including the first camera, wherein the providing the information enables managing the first responder personnel from a remote location.

One or more aspects of the subject disclosure include receiving, at a zone management server, zone monitoring information, wherein the receiving the zone monitoring information comprises receiving, from respective camera devices of a plurality of camera devices, video information and area measurement information for a predetermined zone, communicating, by the zone management server, with a user device of a user, selected portions of the zone monitoring information and zone management information, storing, in a camera database, information about respective locations of the respective camera devices and respective field of view information of the respective camera devices, and receiving, from the user device, information defining a zone of interest to the user, wherein the zone of interest to the user includes at least in part the predetermined zone. Aspects of the subject disclosure further include determining, responsive to the information defining the zone of interest to the user and the area measurement information for the predetermined zone, information defining a three-dimensional map for the zone of interest to the user, storing, in a zone database, information defining the three-dimensional map for the zone of interest to the user, receiving, at the zone management server, rule information defining one or more rules, each respective rule of the one or more rules having criteria requiring satisfaction for the respective rule to be met, retrieving, from the zone database, past video information for the zone of interest, comparing the past video information for the zone of interest with current video information for the zone of interest to determine compliance with a rule of the one or more rules, and providing, to the user device, an indication of the compliance with the rule of the one or more rules, wherein the providing is based on the comparing.

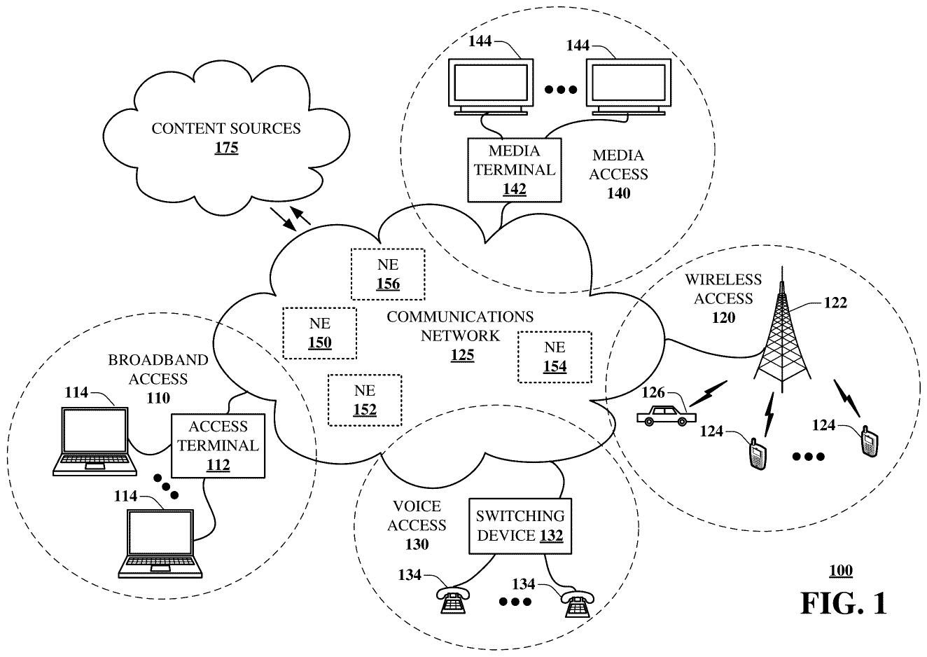

Referring now to FIG. 1, a block diagram is shown illustrating an example, non-limiting embodiment of a system 100 in accordance with various aspects described herein. For example, system 100 can facilitate in whole or in part defining, monitoring and managing three-dimensional virtual zones by users such as first responders. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

A problem exists in that users do not currently have a convenient means by which to define and manage areas, particularly when they are not present at the location. For example, first responders include police, fire and other emergency services personnel. What multiple first responders are addressing and resolving a situation, the activities and locations of the first responders may require management and coordination by a team manager, who may be located remotely in a dispatch center or other location, or may be on-site at the scene.

This is necessary for the user to be able to properly manage areas for which they are responsible. An exemplary embodiment is presented in this disclosure of assignments of geographic areas as zones for first responders. However, the solution may be likewise applied to other types of areas such as a home, public places, outdoor areas, workplaces, and others in which one or more persons are designated for control or management of a particular region or area or room or space.

The solution can be implemented using the system 100 illustrated in FIG. 1, which depicts a communications network 125 that integrates various access technologies including broadband access 110, wireless access 120, voice access 130, and media access 140. The network facilitates communication between multiple devices such as data terminals 114, mobile devices 124, telephony devices 134, and media display devices 144. The network elements NE 150, 152, 154, 156 manage the data flow and connectivity across these access points. This setup allows for the seamless transmission and reception of data, enabling the management of first responder zones by leveraging the connectivity and data processing capabilities of the network.

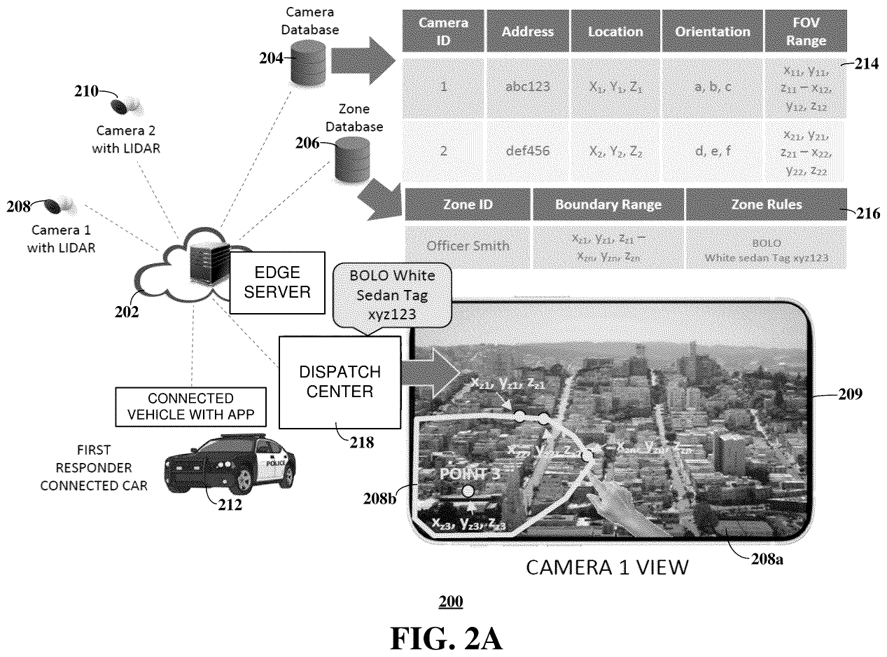

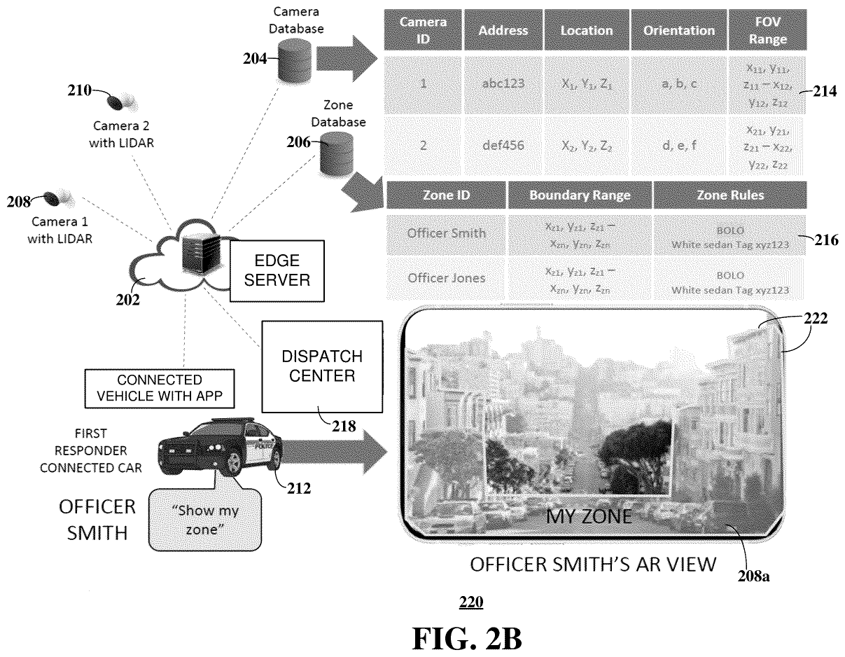

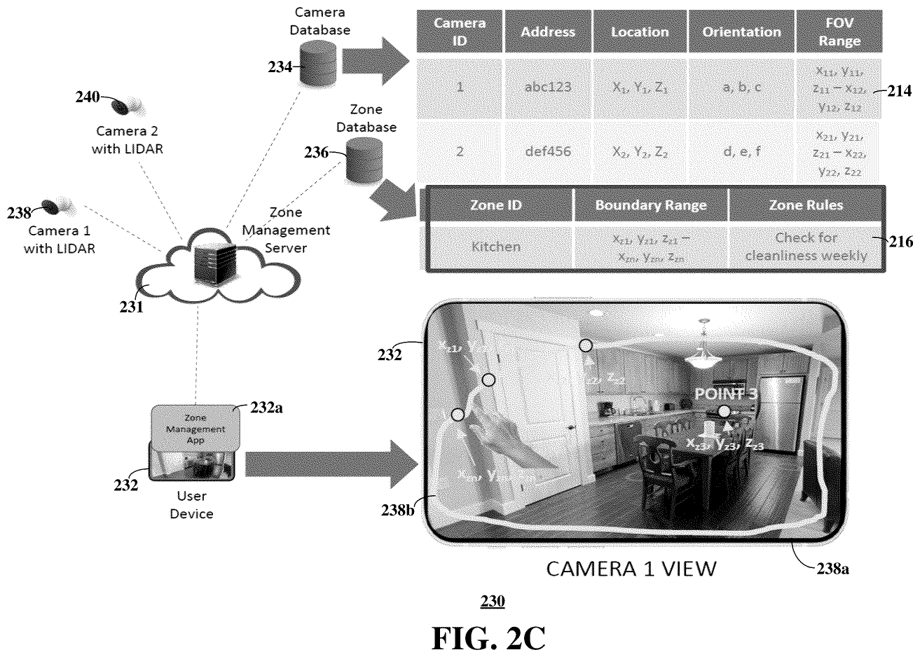

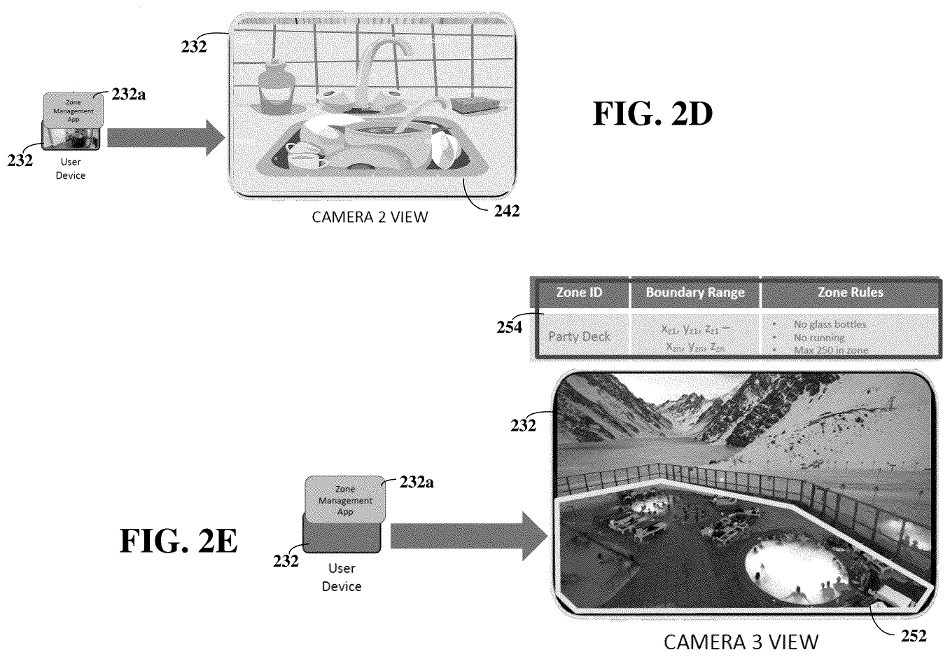

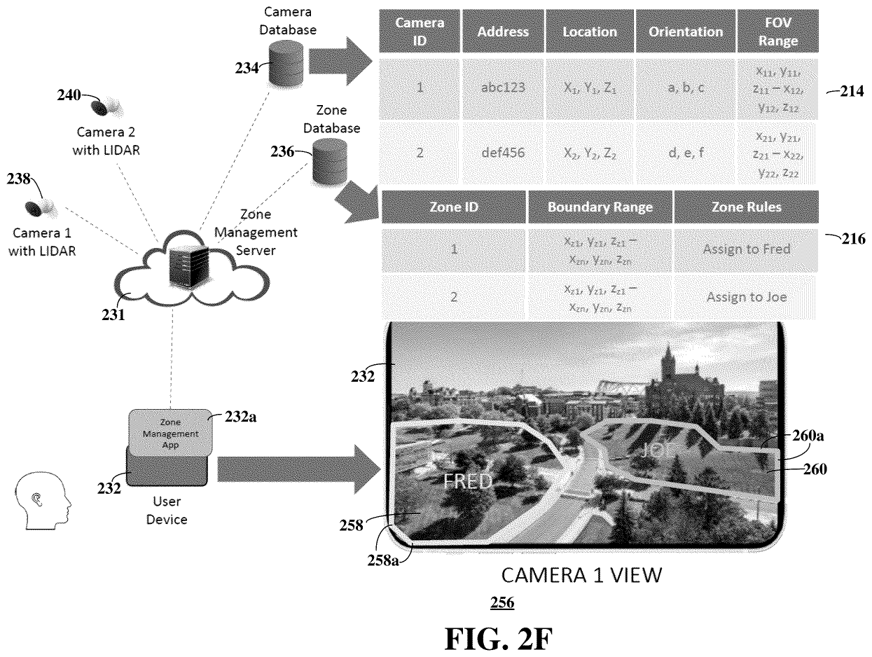

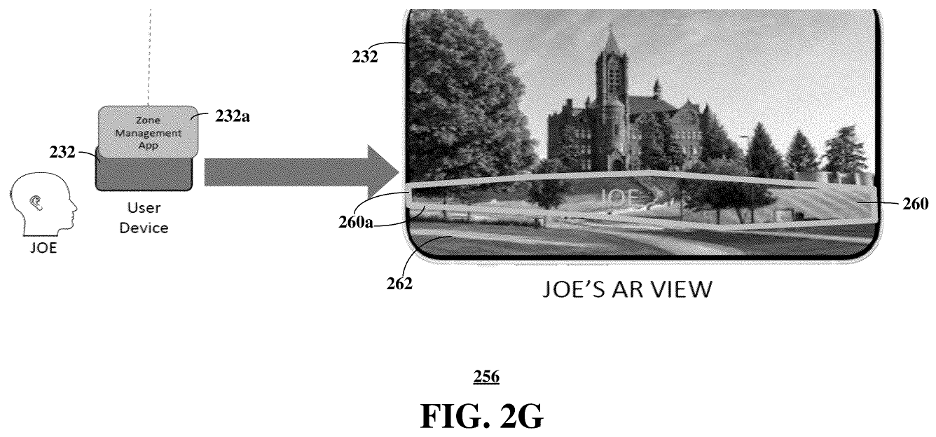

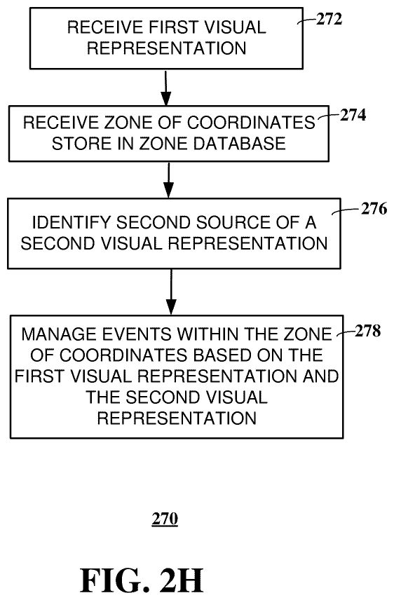

FIG. 2A is a block diagram illustrating an example, non-limiting embodiment of a system 200 functioning within the communication network of FIG. 1 in accordance with various aspects described herein. FIG. 2A illustrates an example system 200 for managing first responder zones within the communications network 125 depicted in FIG. 1. The system 200 includes several key components that work together to enable the definition, monitoring, and management of zones for first responders.

The exemplary system 200 includes an edge server 202, a camera database 204, a zone database 206, a plurality of cameras including a first camera system including a first camera 208, and a second camera system including a second camera 210, and a dispatch center 218. In other embodiments, the system 200 may include more or different camera systems as well as sensors of all types for detecting a physical condition, such as motion sensors. Components of the system 200 communicate data and other information over one or more networks including portions of the communications network 125 of FIG. 1. In the exemplary embodiment, the system 200 interacts with a first responder in a connected vehicle 212. In other embodiments, the system 200 may interact with more or different first responders who may be on foot, in airborne vehicles or located elsewhere. The first responder personnel and other personnel communicate using any suitable data communication network such as a mobility network or wireless access 120 (FIG. 1). To that end, the first responder personnel and others may carry mobile devices such as mobile devices 124.

The edge server 202 acts as the central processing unit of the system 200. The edge server 202 is responsible for receiving data from various sources, processing this data, and managing events within the defined zones. The edge server 202 communicates with both the camera database 204 and the zone database 206 to retrieve and store necessary information.

The camera database 204 stores detailed information about each camera or camera system in the system 200, including unique identifiers for each camera, network addresses for accessing the cameras, geographical coordinates of the cameras, the orientation or direction in which each camera is facing, and the spatial range that each camera can cover, including both visual and Light Detection and Ranging (LiDAR) sensing capabilities. This may be referred to as the field of view (FOV) for the camera and may be defined as a set of coordinates in three dimensions. In embodiments, the camera database 204 may store any other suitable information as well. In the exemplary embodiment, the edge server 202 controls storage and retrieval access to the camera database 204.

The zone database 206 stores information about the defined zones, including unique identifiers for each zone, the three-dimensional coordinates that define the boundaries of each zone, and specific rules and criteria that must be met within each zone, such as monitoring tasks, security protocols, or maintenance instructions. In embodiments, the zone database 206 may store any other suitable information as well. In the exemplary embodiment, the edge server 202 controls storage and retrieval access to the zone database 206.

The system features cameras with LiDAR capabilities. Camera 1 or first camera 208 provides a visual representation of the environment and is equipped with a LiDAR sensor that calculates the three-dimensional coordinates of points within its field of view. The user can define a zone by tracing its boundary on a touch screen device, and the corresponding coordinates are stored in the zone database. Camera 2 or second camera 210 also has LiDAR capabilities and provides a second visual representation. The edge server identifies second camera 210 as having a field of view that overlaps with the defined zone, allowing for additional monitoring and data collection.

The system 200 can include any number of cameras or camera systems. As noted, the first camera 208 and the second camera 210 are equipped with LiDAR sensors as well as location determining devices and thus may be referred to as camera systems. Data defining images or a video feed, as well as LiDAR sensor data, may be communicated from each respective camera system to the edge server 202. The location determining device may be, for example, a Global Positioning System (GPS) receiver configured to receive GPS signals and determine physical location information, thus making the camera system location-aware. Each camera system may generate and communicate zone information which includes video information and area measurement information for a predetermined zone covered or viewed by a camera and LiDAR sensor. In embodiments, each camera or camera system can register with the system 200. Once activated, each camera registers itself with the camera database 204. Registration may include providing location information, network address information and other information for storage in a database record 214 of the camera database 204.

The first responder connected car or connected vehicle 212 is equipped with a networked and location-aware smart device that includes an application for communication with the edge server 202. The edge server 202 may have a complementary server application for controlling the and communicating with devices in the system 200 such as connected vehicle 212. The connected vehicle 212 receives instructions and augmented reality displays from the edge server 202, helping first responders navigate and manage their assigned zones effectively.

The dispatch center 218 is in communication with the edge server 202, the camera database 204, and the zone database 206. The dispatch center 218 serves as the command center for managing first responder activities in the system 200. The dispatch center 218 includes any suitable number and type of user devices such as user device 209. The user devices enable interaction with the edge server 202 including application programs running on the edge server 202. The user devices further allow viewing information from sensors such as the first camera 208 and second camera 210 as well as control of these devices. For example, the first camera 208 may be mounted on a pole and capable of moving in azimuth and elevation to view selected areas of a predetermined zone. Users of the dispatch center 218 can view video streams such as image 208a on the user device 209 from the cameras including first camera 208 and second camera 210, define zones, issue instructions, and monitor compliance with zone rules. The dispatch center 218 can also communicate with first responders on the scene via their connected cars and other mobility devices.

In embodiments, access to the dispatch center 218 is controlled and limited to authorized users. A dispatch center user may log in to the server with credentials that enable the user to access cameras for which the user has permission. That is, when the dispatch center user logs in to the server, the edge server 202 maintains a listing of cameras for which the dispatch center user has management responsibilities. For the example shown, the dispatch center user has access to first camera 208 and second camera 210.

The dispatch center user may select a camera for which to view a stream of video. A video stream from the camera flows to the edge server 202 and then to the user of the dispatch center 218, for example, to view the video stream from first camera 208. In some embodiments, the dispatch center user may instead perform their tasks on a mobile basis using a wireless device with an application (app). Therefore, the user of the dispatch center 218 may be on scene, managing other first responders. Further, the user of the dispatch center 218 may be mobile in a vehicle, vessel or aircraft.

In some embodiments, the system 200 operates as follows. The edge server 202 receives a first visual representation from first camera 208 and an indication of a zone of coordinates comprising at least a portion of the first visual representation. The indication of the zone of coordinates may originate from, for example, the location aware first camera 208 or the camera database 204. The edge server 202 stores information about the zone of coordinates in the zone database 206. The edge server 202 identifies the second camera 210 as a second source that produces a second visual representation, which includes at least a portion of the zone of coordinates. The edge server 202 manages events within the zone of coordinates based on the first and second visual representations. Managing events may include issuing instructions to be performed within the zone and analyzing the visual representations for compliance with zone rules.

With the view of the first camera 208 presented as image 208a to the user of the dispatch center 218 on the user device 209, the user may specify a zone boundary 208b by, for example, tracing an outline of the zone boundary 208b using a finger on a touch screen of the user device 209. The boundary created is presented visually and a series of points along the boundary are represented as points of the boundary.

With the LiDAR sensor associated with the first camera 208 oriented in the same direction as the camera view, a corresponding three-dimensional map may be overlaid on top of the boundary traced. Therefore, a series of three-dimensional coordinates are assigned to the points along the zone boundary 208b. This is possible since the camera is location-aware and also is aware of its orientation within space. Therefore, the LiDAR sensor calculates the coordinates of points along the boundary. This information may be communicated to the edge server 202 and stored in the zone database 206 as a record 216.

The system 200 enables the creation of augmented reality displays for first responders, showing the boundaries and rules of their assigned zones. Augmented reality (AR) is a visual presentation technology that overlays digital or virtual information onto images of the real world. AR systems typically use cameras, sensors, and displays to capture the real-world environment and then integrate digital content like 3D models, images, or videos into the scene. This creates a composite view where the digital elements appear to be part of the real world. This augmented reality presentation by the system 200 can be requested by the first responder via a spoken request or other means, and it helps enhance situational awareness and coordination on the scene. The edge server can also communicate with a team manager at a dispatch center location or with a mobile device of the team manager at a mobile location, ensuring seamless management of first responder activities.

Either concurrently or after the zone boundary 208b is defined, the user at the dispatch center 218 specifies a zone identifier or zone ID. In one embodiment, for instance, while tracing the zone boundary 208b, the user issues a voice command which is sent to the edge server 202 along with the set of coordinates that define the zone boundary 208b, such that the spoken definition of a zone ID is collected at the same time while the zone is being created. As a result, a zone ID is stored in record 216 the zone database 206 along with the range of points that make up the zone boundary 208b of the zone. The zone itself therefore constitutes not only the zone boundary 208b, but also the range of all three-dimensional coordinates that exist within the zone boundary 208b. For example, in FIG. 2A, the point in the camera view or image 208a labelled Point 3 exists within the zone and its coordinates in space are likewise determined by the LiDAR mapping that occurs at the time of the definition of the zone boundary 208b.

For each zone stored in the zone database 206, one or more zone rules are defined and saved in the zone database 206. The zone rules are defined such that each rule has criteria that must be satisfied for the rule to be met. As an example, these rules may indicate an order or direction for a first responder as they pertain to the zone.

FIG. 2B is a block diagram illustrating a second example, non-limiting embodiment of a system 220 functioning within the communication network of FIG. 1 in accordance with various aspects described herein. FIG. 2B illustrates an example system 220 for managing first responder zones within the communication network depicted in FIG. 1 and builds upon the system described in FIG. 2A. The system 220 includes several key components that work together to enable the definition, monitoring, and management of zones for first responders.

Similar to system 200 of FIG. 2A, the edge server 202 acts as the central processing unit of the system. It is responsible for receiving data from various sources, processing this data, and managing events within the defined zones. The edge server 202 communicates with both the camera database 204 and the zone database 206 to retrieve and store necessary information.

The camera database 204 stores detailed information about each camera in the system, including unique identifiers for each camera, network addresses for accessing the cameras, geographical coordinates of the cameras, the direction in which each camera is facing, and the spatial range that each camera can cover, including both visual and Light Detection and Ranging (LiDAR) sensing capabilities.

The zone database 206 stores information about the defined zones, including unique identifiers for each zone, the three-dimensional coordinates that define the boundaries of each zone, and specific rules and criteria that must be met within each zone, such as monitoring tasks, security protocols, or maintenance instructions.

The system features cameras with LiDAR capabilities. The first camera 208 provides a first visual representation 208a of the environment and is equipped with a LiDAR sensor that calculates the three-dimensional coordinates of points within its field of view. The user can define a zone by tracing its boundary on a touch screen device, and the corresponding coordinates are stored in the zone database 206. The second camera 210 also has LiDAR capabilities and provides a second visual representation. The edge server 202 identifies second camera 210 as having a field of view that overlaps with the defined zone, allowing for additional monitoring and data collection.

The first responder connected car or vehicle 212 is equipped with a networked and location-aware smart device that includes an application for communication with the edge server 202. The connected car receives instructions and augmented reality displays from the edge server, helping first responders navigate and manage their assigned zones effectively.

The dispatch center 218 is in communication with the edge server 202, the camera database 204, and the zone database 206. The dispatch center 218 serves as the command center for managing first responder activities. Dispatch center users can view video streams from the cameras, define zones, issue instructions, and monitor compliance with zone rules. The dispatch center 218 can also communicate with first responders on the scene via their connected cars such as vehicle 212.

In FIG. 2B, the system operates as follows. The edge server 202 receives a first visual representation 208a from first camera 208 and an indication of a zone of coordinates comprising at least a portion of the first visual representation. The edge server 202 stores information about the zone of coordinates in the zone database 206. The edge server identifies second camera 210 as a second source that produces a second visual representation, which includes at least a portion of the zone of coordinates. The edge server 202 manages events within the zone of coordinates based on the first and second visual representations. This includes issuing instructions to be performed within the zone and analyzing the visual representations for compliance with zone rules indicated in a record 216 of the zone database 206.

The system enables the creation of augmented reality displays for first responders, showing the boundaries and rules of their assigned zones. This augmented reality presentation can be requested by the first responder via a spoken request or other means, such as the “Show my zone” command, and it helps enhance situational awareness and coordination on the scene. The edge server 202 can also communicate with a team manager at a dispatch center location or with a mobile device of the team manager at a mobile location, ensuring seamless management of first responder activities.

In the example of FIG. 2B, alternate camera views are used by the user at the dispatch center 218 and used by the edge server 202 to create augmented reality virtual boundary displays sent to each assigned Zone ID Owner. In this case each zone owner is a first responder. So, for example, the augmented reality boundary 222 for Officer Smith's view may be presented to him so that he knows the boundary of his assignment. The boundary 222 is superimposed on the visual representation seen by Officer Smith on his user device, using AR technology or similar process. This augmented reality presentation can also be presented as a response to a request from the first responder that is uttered as a spoken request that is sent to the server. In the example of FIG. 2B, Officer Smith provides the oral command to “show my zone.” The command may otherwise be entered using other means such as a keyboard or touch pad display as well.

In FIG. 2B, Officer Smith's augmented reality view is shown, which highlights the boundary 222 of the assigned zone. This view is generated based on the data stored in the zone database 206 and the visual representations from the first camera 208 and the second camera 210. The system 220 ensures that first responders have a clear understanding of their designated areas and the rules they need to follow, thereby improving the efficiency and effectiveness of their operations.

FIG. 2C is a block diagram illustrating a second example, non-limiting embodiment of a system 230 functioning within the communication network of FIG. 1 in accordance with various aspects described herein. FIG. 2C illustrates an example system 230 for managing zones within the communications network 125 depicted in FIG. 1 and builds upon the systems described in FIG. 2A. The system includes several key components that work together to enable the definition, monitoring, and management of zones. The zones are in effect zones or areas for which the user has management responsibilities. In the illustrated example, the zones are areas within a residence. Responsibilities of a user may include cleaning and keeping clean a designated zone such as a dining area or kitchen sink and counter.

In the example embodiment of FIG. 2C, the user may be equipped with a networked and location-aware smart device such as a smartphone or tablet computer. There also exists two or more cameras that are present in the vicinity of a zone for which the user has management responsibilities. These cameras are location-aware and networked and also have three-dimensional sensing capabilities such as LiDAR sensors. These LiDAR sensors are oriented such that they are directed to the same field of view as the camera's visual view.

A zone management server 231 acts as the central processing unit of the system. It is responsible for receiving data from various sources, processing this data, and managing events within the defined zones. The zone management server 231 communicates with both a camera database 234 and a zone database 236 to retrieve and store necessary information.

The camera database 234 stores detailed information about each camera in the system, including unique identifiers for each camera, network addresses for accessing the cameras, geographical coordinates of the cameras, the direction in which each camera is facing, and the spatial range that each camera can cover, including both visual and Light Detection and Ranging (LiDAR) sensing capabilities. Data in the camera database 234 may be stored in records such as record 214.

The zone database 236 stores information about the defined zones, including unique identifiers for each zone, the three-dimensional coordinates that define the boundaries of each zone, and specific rules and criteria that must be met within each zone, such as monitoring tasks, security protocols, or maintenance instructions. Data in the zone database 236 may be stored in records such as record 216.

The system 230 features cameras with LiDAR capabilities. First camera 238 provides a visual representation or view 238a of the area or the environment where the first camera 238 is located. First camera 238 may be part of a camera system and be matched with or equipped with a LiDAR sensor that calculates the three-dimensional coordinates of points within its field of view. The user can define a zone by tracing its boundary 238B on a touch screen device such as user device 232, and the corresponding coordinates are stored in the zone database 236. Second camera 240 also has LiDAR capabilities and provides a second visual representation. The zone management server 231 identifies the second camera 240 as having a field of view that overlaps with the defined zone, allowing for additional monitoring and data collection by the system 230 including the zone management server 231.

In embodiments according to FIG. 2C, the system 230 operates as follows. The zone management server 231 receives a first visual representation or view 238a from the first camera 238 and an indication of a zone of coordinates comprising at least a portion of the first visual representation or view 238a. The zone management server 231 stores information about the zone of coordinates in the zone database 236. The zone management server 231 identifies second camera 240 as a second source that produces a second visual representation, which includes at least a portion of the zone of coordinates. The zone management server 231 manages events within the zone of coordinates based on the first and second visual representations. This may include issuing instructions to be performed within the zone and analyzing the visual representations for compliance with zone rules such as the rules specified for the zone in record 216 of zone database 236.

The system 230 enables the creation of augmented reality displays for users, showing the boundaries such as boundary 238b and rules of their assigned zones. This augmented reality presentation can be requested by the user via a spoken request or other means, and it helps to manage and oversee the scene. The zone management server 231 can also communicate with a user associated with a mobile device 232 at any suitable location. In the example, the mobile device 232 operates according to an application program or app 232a. The app 232a may cooperate with a server application of the zone management server 231. Thus, user device 232 may be equipped with a zone management app 232a that is in communication with the zone management server 231. The zone management server 231 may also have access to the camera database 234 and the zone database 236 over any suitable data communication network.

In operation of the system 230, the cameras may be activated on the system 230. Once activated, each camera may register itself with the camera database 234. The user may log in to the zone management app 232a on the user device using credentials that enable the user to access cameras for which the user has permission. That is, when the user uses the zone management app 232a on the user device 232 to log in to the zone management server 231, the zone management server 231 may maintain a listing of cameras for which the user has management responsibilities. For the example shown, the user has access to the first camera 238 and the second camera 240. The user may use the zone management app 232a to select a camera for which to view a stream of video. A video stream from the camera flows to the zone management server 231 and then to the user at the user device 232 via the zone management app 232a, for example, to view the stream from first camera 238. The camera database 234 may store records for each registered camera which also include data such as a unique address for each camera, the location of the camera, its orientation, and a field of view range that incorporates the camera's range of not only its camera function but also its LiDAR function.

As indicated in FIG. 2C, the user may define one or more zones in the area shown in the display. With the view 238a from first camera 238 presented to the user on the user device 232, the user may specify a boundary 238b by, for example, tracing an outline of the boundary using their finger on a touch screen of the user device 232. The boundary 238b created may be presented visually and a series of points along the boundary 238b may be represented as points of the boundary 238b. With the LiDAR sensor oriented in the same direction as the camera view, a corresponding three-dimensional map may be overlaid on top of the traced boundary 238b. Therefore, a series of three-dimensional coordinates may be assigned to the point along the boundary 238b. This is possible since the camera is location-aware and also is aware of its orientation within space. Therefore, the LiDAR sensor may calculate the coordinates of points along the boundary 238b.

Either concurrently or after the boundary 238b of the zone is defined, the user may specify a zone identifier or zone ID. In one embodiment, for instance, while tracing the boundary 238b, the user may issue a voice command which may be sent from the zone management app 232a to the zone management server 231 along with the set of coordinates that define the zone boundary 238b, such that the spoken definition of a zone ID is collected at the same time while the zone is being created. As a result, a zone ID may be stored in the zone database 236 along with the range of points that make up the boundary 238b of the zone. The zone itself therefore constitutes not only the boundary 238b, but also the range of all three-dimensional coordinates that exist within the boundary 238b. For example, the point designated as Point 3 exists within the zone and its coordinates in space are likewise determined by the LiDAR mapping that occurs at the time of the definition of the zone boundary 238b.

Further, for each zone, one or more zone rules may be defined and saved in the zone database 236. The zone rules may be defined such that each rule has criteria that must be satisfied for the rule to be met. As an example, a rule may be established to keep an area clean. A “clean” area may be defined to include visible areas to be neat and tidy and stocked in a particular manner. That is, certain items may be defined as being required to be in certain locations. Other examples of rules may include, for instance, activities that are required to be performed at certain times within a zone or activities that should not be required or be performed within the zone. For example, a zone may have an occupancy limit in terms of the number of people who can be within the zone; smoking may be prohibited in the zone; certain types of items may be prohibited from the zone, etc. Or, in another example, a person or robot may be assigned to complete a task within a zone within a certain time period.

FIG. 2D is an example of operation of the system 230 of FIG. 2C. FIG. 2D illustrates an image 242 of a particular area in a residence that is monitored for rules compliance by the system 230. The system 230 may also check for compliance of zone rules when compliance can be determined based on capabilities of ambient sensors in the area. For example, the zone management server 231 may analyze video from the first camera 238 and compare a current image 242 from the camera with the zone rules defined for elements of the video stream from the first camera 238 that are within the zone. For example, the zone management server 231 may compare the image from first camera 238 with the conditions defined for cleanliness of the zone and note any items that are amiss within the zone.

Likewise, the zone management server 231 may also analyze streams or images from other cameras in the vicinity. Since these cameras are also location aware, the field of view of these cameras may be compared with the boundary range of the zone. Therefore, the zone defined using the image from the first camera 238 may also include some locations that are viewable by the second camera 24. In the example shown, the second camera 240 may include viewable points that are all included within the boundary of the zone. The image from second camera 240 may be presented on the user device 232 in conjunction with operation of the zone management app 232a.

In other cases, the alternative camera view may only contain some points of the zone, but from a different orientation. In all cases however, the field of view range for each camera that includes at least one point that is within the boundary range of the zone is an indication of the camera being one that may be used to monitor compliance of rules that apply to the zone.

FIG. 2E is an example of operation of the system of FIG. 2C. In the example of FIG. 2E, an area under management includes an outdoors space with a deck and pool or hot tub. An image 252 from a camera may be displayed on the user device 232 in conjunction with app 232a. In this example, the exterior area may be modified or managed to comply with a number of rules. These are rules that may be enforced through visual analysis from camera feeds. For example, rules such as occupancy limits, actions taken, prohibited items, and others are demonstrated in this example. In addition, the user may use the zone management app to issue a command to be executed in real time within the zone. In an example, a user with responsibility for managing the pictured area states a command, “find anyone without a number wristband,” where such wristbands are required for authorized access. In some cases, the command may be for the zone management server 231 to perform an action or an analysis using the multiple camera angles available of the defined zone area. For example, the user may request the zone management server 231 to perform a video analysis to find any occupant that is not compliant with a member wristband within the zone.

In other exemplary cases, a zone management command may be issued by the user to perform an action in real time or at a scheduled time. This command specifying this action may be sent to the zone management server 231 which in turn may assign it to another entity to perform. The other entity may be a person or, for example, a robot. In either case, the task assignment is communicated along with a defined set of coordinates of the zone in which to perform the task.

FIG. 2F is an example of operation of a system 256 in accordance with various aspects described herein. The system 256 includes, similar to system 230 in FIG. 2C, a zone management server 231, a camera database 234, a zone database 236, cameras including first camera 238 and second camera 240. The zone management server 231 may cooperate with a user device 232 which implements a zone management app 232a for use by a user. Information about the cameras may be collected when the cameras register with the system 256 and stored as records such as record 214 in the camera database 234. Similarly, the user may define a first area 258 and a second area 260. In embodiments, the areas may be defined by use of a touch screen of the user device 232 when the user device 232 displays an image from one of the cameras of the environment. The first area 258 may be defined, for example, by drawing its boundary 258a on the touch screen. Similarly, the second area 260 may be defined by drawing its boundary 260a on the touch screen. In the manner described herein, or in any suitable manner, the information about each respective area may be stored in the zone database 236 according to a zone identifier or zone ID. For each zone, zone rules may be defined including a rule which indicates to which individual management of the zone is assigned, Fred and Joe in the illustrated example.

Thus, in some cases such as the illustrated example, multiple zones may be defined for an environment. One application for this is in division of work related to an area that includes the zones such as first area 258 and second area 260. This may be work performed by a person, a robot, or another machine. As an example, in FIG. 2F, a supervisor may wish to divide landscaping responsibilities between two employees, Fred and Joe. Two zones, including first area 258 and second area 260, may be created and the zone rules may be used to define the assignments.

FIG. 2G is an example of operation of the system 256 of FIG. 2F in accordance with various aspects described herein. In FIG. 2G, the user is the employee Joe who uses the user device 232 to create an AR image or AR view 262 of the area 260 for which he is responsible. The user device 232, in cooperation with the zone management server 231, forms the AR view by combining area measurement information from the LiDAR sensors associated with the cameras with video information from the cameras. The video information from camera devices and area measurement information from the camera devices for a particular zone may be considered to be zone monitoring information.

In this illustrated example, alternate camera views may be used by each user and used by the zone management server 231 to create augmented reality virtual boundary displays such as AR view 262 which may be sent to each assigned user. In this example, then, the augmented reality boundary for Joe's view may be presented to him so that he knows the boundary of his assignment.

FIG. 2H depicts an illustrative embodiment of a method in accordance with various aspects described herein. FIG. 2H illustrates a method 270 for managing first responder zones within the communication network depicted in FIG. 1 and builds upon the system described in FIG. 2A. The method 270 includes several steps that work together to enable the definition, monitoring, and management of zones for first responders.

The method begins with step 272, where an edge server or a zone management server or similar device receives a first visual representation from a first camera. This visual representation is part of the data communicated over the communications network 125, which integrates various access technologies including broadband access 110, wireless access 120, voice access 130, and media access 140. The first visual representation provides a view of an environment that is essential for defining one or more zones.

In step 274, the server receives an indication of a zone of coordinates comprising at least a portion of the first visual representation. This information may be stored in a convenient location such as in a zone database. The zone coordinates are defined using the LiDAR capabilities of a camera system or separate LiDAR sensor, which calculates the three-dimensional coordinates of points within its field of view. The user can define a zone by tracing its boundary on a touch screen device, and the corresponding coordinates are stored in the zone database.

Next, in step 276, the server identifies a second source, such as a second camera, that produces a second visual representation. This second visual representation includes at least a portion of the zone of coordinates. The server uses the information stored in a convenient location such as a camera database, which includes details about each camera's location, orientation, and field of view range, to identify the second source.

Finally, in step 278, the server manages events within the zone of coordinates based on the first visual representation and the second visual representation. This includes issuing instructions to be performed within the zone and analyzing the visual representations for compliance with zone rules. For example, a user, in communication with the server, can view video streams from the cameras, define zones, issue instructions, and monitor compliance with zone rules. In some examples, a user or team leader in a dispatch center can also communicate with first responders on a scene via connected cars or other mobile devices.

The method described in FIG. 2H links to the broader system illustrated in FIG. 1 by leveraging the integrated communication network 125 and the various access technologies to facilitate seamless data transmission and reception. The system described in FIG. 2A provides the necessary infrastructure and components, such as the edge server 202, camera database 204, and zone database 206, to support the method steps of method 270 outlined in FIG. 2H. This comprehensive approach ensures effective management of first responder zones, enhancing situational awareness and coordination on the scene.

While for purposes of simplicity of explanation, the respective processes are shown and described as a series of blocks in FIG. 2H, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

Alternate embodiments of the subject matter of the disclosure can be applied in various ways, leveraging the components and methods described in FIGS. 1, 2A through 2H, and the claims. One alternate embodiment could involve the use of additional types of sensors beyond cameras and LiDAR. For example, thermal imaging cameras could be integrated into the system to provide additional data for monitoring zones, especially in low-visibility conditions such as smoke or darkness. These thermal cameras could be registered in the camera database 234 and their data processed by the edge server 232 to enhance situational awareness.

Another embodiment could include the use of drones equipped with cameras and LiDAR sensors. These drones could be deployed to provide aerial views of the zones, offering a different perspective that complements the ground-based cameras. The drones could be controlled via the edge server 231 and their data integrated into the zone database 236. This would allow for dynamic and flexible monitoring of large or complex areas.

The system could also be adapted for use in non-emergency scenarios, such as facility management or event security. For instance, in a large industrial facility, the system could be used to monitor safety compliance and equipment status. The zone rules could include criteria for equipment operation, personnel safety gear, and restricted access areas. The edge server 231 may manage events within these zones, ensuring compliance with safety protocols.

In a smart city context, the system could be used to manage public spaces. Cameras and sensors could monitor parks, streets, and public buildings for maintenance needs, security issues, and rule compliance. The zone management server 231 could communicate with city management applications to coordinate responses to detected issues, such as dispatching maintenance crews or alerting law enforcement.

The system could also be integrated with other smart technologies, such as smart lighting and environmental sensors. For example, in a smart building, the system could adjust lighting and HVAC settings based on occupancy data from the cameras and LiDAR sensors. This would enhance energy efficiency and occupant comfort.

In terms of user interaction, the system could support more advanced augmented reality (AR) features. First responders or facility managers could use AR glasses to view real-time data overlays on their field of view, showing zone boundaries, sensor data, and instructions. This would provide hands-free access to critical information, improving efficiency and safety.

Additionally, the system could incorporate machine learning algorithms to analyze historical data and predict potential issues. For example, the edge server 231 could use past video information and sensor data to identify patterns that precede equipment failures or security breaches. This predictive capability would allow for proactive management and maintenance.

Finally, the system could be designed to support interoperability with other emergency response systems. For example, it could integrate with 911 dispatch systems, fire department networks, and hospital communication systems. This would enable seamless coordination across different agencies and improve the overall effectiveness of emergency response efforts.

These alternate embodiments demonstrate the flexibility and scalability of the subject matter of the disclosure, allowing it to be adapted for a wide range of applications beyond the initial scope of first responder zone management.

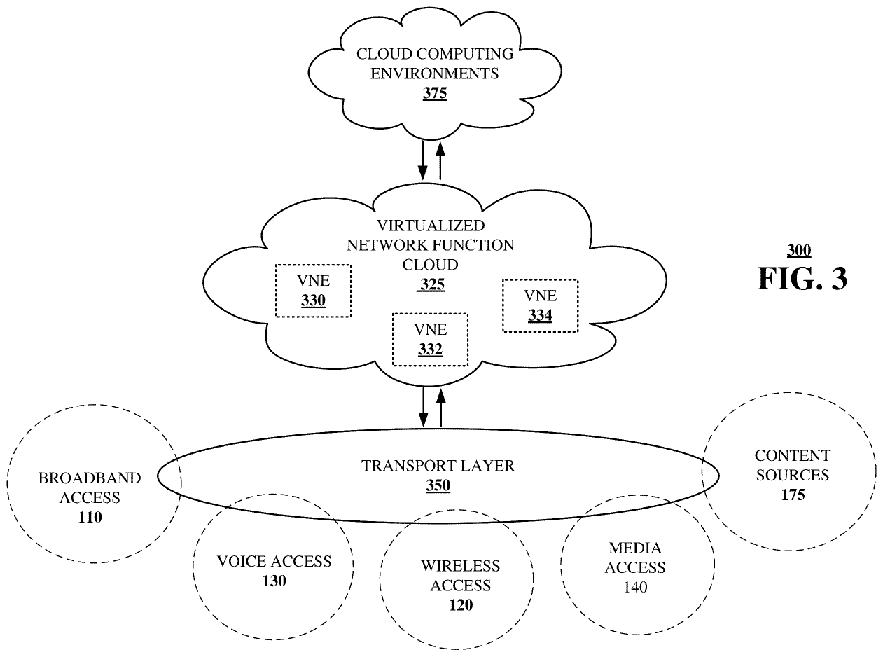

Referring now to FIG. 3, a block diagram is shown illustrating an example, non-limiting embodiment of a virtualized communication network in accordance with various aspects described herein. In particular a virtualized communication network 300 is presented that can be used to implement some or all of the subsystems and functions of system 100, the subsystems and functions of system 200, system 220, system 230 and method 270 presented in FIG. 1, FIG. 2A, FIG. 2B, FIG. 2C, FIG. 2F, FIG. 2H, and FIG. 3. For example, virtualized communication network 300 can facilitate in whole or in part defining, monitoring and managing three-dimensional virtual zones by users such as first responders.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements—which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized and might require special DSP code and analog front ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward large amounts of traffic, their workload can be distributed across a number of servers - each of which adds a portion of the capability, and which creates an elastic function with higher availability overall than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud or might simply orchestrate workloads supported entirely in NFV infrastructure from these third-party locations.

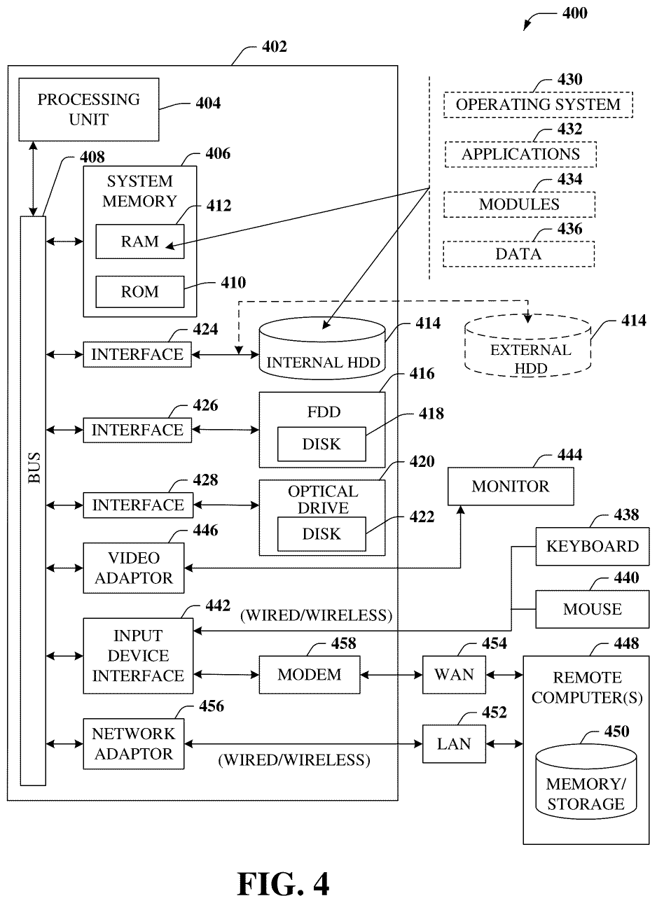

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part defining, monitoring and managing three-dimensional virtual zones by users such as first responders.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

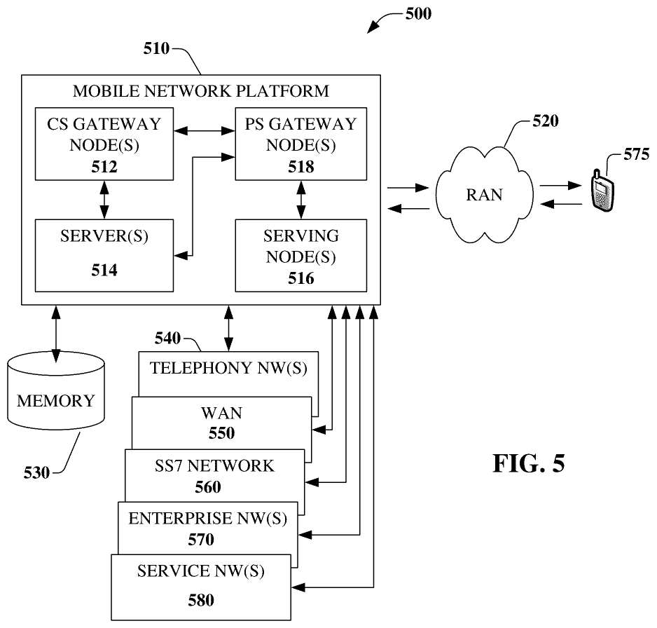

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part defining, monitoring and managing three-dimensional virtual zones by users such as first responders. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technologies utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

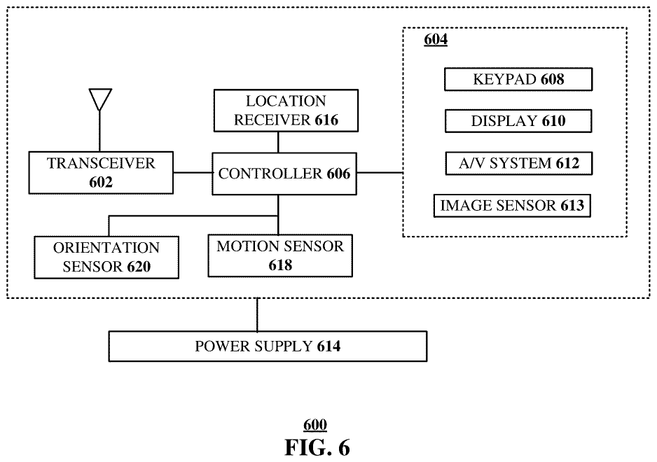

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, communication device 600 can facilitate in whole or in part defining, monitoring and managing three-dimensional virtual zones by users such as first responders.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high-volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x₁, x₂, x₃, x₄ . . . xₙ), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A method, comprising:
receiving, by a processing system including a processor associated with a network node, data of a first visual representation from a first source, the first source configured to produce the first visual representation;
receiving, by the processing system, an indication of a zone of coordinates comprising at least a portion of the first visual representation;
storing, by the processing system, information about the zone of coordinates;
identifying, by the processing system, a second source configured to produce a second visual representation, wherein the second visual representation includes at least a portion of the zone of coordinates; and
managing, by the processing system, events within the zone of coordinates based on the first visual representation and the second visual representation.

2. The method of claim 1, wherein the managing events within the zone of coordinates comprises:
issuing, by the processing system, an instruction to be performed within the zone of coordinates.

3. The method of claim 1, wherein the managing events comprises:
receiving, by the processing system, a rule corresponding to the zone of coordinates; and
analyzing, by the processing system, the first visual representation and the second visual representation for compliance with the rule.

4. The method of claim 3, wherein the receiving the data of a first visual representation comprises:
receiving, by the processing system, information defining the rule for the zone of coordinates.

5. The method of claim 4, wherein the managing events comprises:
assigning, by the processing system, a first zone within the zone of coordinates to a first team member; and
communicating, by the processing system, information about assignment of the first zone to the first team member.

6. The method of claim 5, wherein the assigning the first zone within the first zone of coordinates comprises:
presenting, by the processing system, the first visual representation on a display device to a team manager;
receiving, by the processing system, a first zone definition indication from the team manager; and
communicating, by the processing system, the first zone definition indication to the first team member.

7. The method of claim 6, wherein the receiving the first zone definition indication from the team manager comprises:
receiving, by the processing system, an indication of a set of coordinates defining the first zone definition indication, wherein the indication of the set of coordinates is received from a touch screen device of the team manager; and
storing, by the processing system, in a zone database, data corresponding to a zone identifier for the set of coordinates, identification information for the first team member, and the information defining the rule.

8. The method of claim 7, further comprising:
correlating, by the processing system, the first visual representation with the first zone definition indication;
developing, by the processing system, an augmented reality virtual display based on the first visual representation and the first zone definition indication; and
communicating, by the processing system, information about the augmented reality virtual display to the first team member for viewing by the first team member on a device of the first team member.

9. The method of claim 8, further comprising:
defining, by the processing system, in the augmented reality virtual display, zone boundaries associated with the first zone definition indication and the first team member; and
communicating, by the processing system, information illustrating the zone boundaries along with the information about the augmented reality virtual display to the first team member for viewing of the zone boundaries by the first team member on the device of the first team member.

10. The method of claim 9, comprising:
receiving, by the processing system, a request from the first team member to view the information illustrating the zone boundaries along with the information about the augmented reality virtual display on the device of the first team member; and
communicating, by the processing system, the information illustrating the zone boundaries along with the information about the augmented reality virtual display in response to the request from the first team member.

11. The method of claim 4, wherein the managing events comprises:
communicating, by the processing system, with a team manager at a dispatch center location; or
communicating, by the processing system, with a mobile device of the team manager at a mobile location, the mobile device including an application program for managing events.

12. A device, comprising:
a processing system including a processor; and
a memory that stores executable instructions that, when executed by the processing system, facilitate performance of operations, the operations comprising:
receiving a first video feed from a first camera, the first video feed showing a view of an environment including the first camera;
receiving a zone of coordinates corresponding to a first field of view of the first camera;
identifying a second camera having a second field of view corresponding at least in part to the first field of view of the first camera, wherein the identifying the second camera is based on the zone of coordinates; and
providing information to first responder personnel located in or near an area including the environment including the first camera, wherein the providing the information enables managing the first responder personnel from a remote location.

13. The device of claim 12, wherein the providing the information to the first responder personnel comprises:
providing instructions to the first responder personnel to direct actions of the first responder personnel.

14. The device of claim 12, wherein the providing the information to the first responder personnel comprises:
receiving information defining a boundary for a zone of responsibility associated with the first responder personnel;
communicating the information defining the boundary;
storing, in a zone database, identification information for the first responder personnel, the information defining the boundary, and rules for defining an assignment for the first responder personnel in the zone of responsibility associated with the first responder personnel; and
communicating the information defining the boundary, and rules for defining an assignment for the first responder personnel to the first responder personnel.

15. The device of claim 12, wherein the operations further comprise:
storing, in a camera database, information identifying the first camera, a network address of the first camera, a geographical location of the first camera, and information about the first field of view of the first camera.

16. A non-transitory machine-readable medium, comprising executable instructions that, when executed by a processing system including a processor, facilitate performance of operations, the operations comprising:
receiving, at a zone management server, zone monitoring information, wherein the receiving the zone monitoring information comprises receiving, from respective camera devices of a plurality of camera devices, video information and area measurement information for a predetermined zone;
communicating, by the zone management server, with a user device of a user, selected portions of the zone monitoring information and zone management information;
storing, in a camera database, information about respective locations of the respective camera devices and respective field of view information of the respective camera devices;
receiving, from the user device, information defining a zone of interest to the user, wherein the zone of interest to the user includes at least in part the predetermined zone;
determining, responsive to the information defining the zone of interest to the user and the area measurement information for the predetermined zone, information defining a three-dimensional map for the zone of interest to the user;
storing, in a zone database, information defining the three-dimensional map for the zone of interest to the user;
receiving, at the zone management server, rule information defining one or more rules, each respective rule of the one or more rules having criteria requiring satisfaction for the respective rule to be met;
retrieving, from the zone database, past video information for the zone of interest;
comparing the past video information for the zone of interest with current video information for the zone of interest to determine compliance with a rule of the one or more rules; and
providing, to the user device, an indication of the compliance with the rule of the one or more rules, wherein the providing is based on the comparing.

17. The non-transitory machine-readable medium of claim 16, wherein the operations further comprise:
receiving, at the zone management server, from the user device, a command to monitor compliance with the one or more rules; and
communicating, by the zone management server, a control information to control a respective camera device of the plurality of camera devices to monitor the zone of interest, wherein the control information is based on the command to monitor compliance.

18. The non-transitory machine-readable medium of claim 16, wherein the zone monitoring information comprises:
receiving a video feed from a camera of a respective camera device; and
receiving three dimensional sensing information from a respective LiDAR sensor of the respective camera device.

19. The non-transitory machine-readable medium of claim 16, wherein the operations further comprise:
receiving, by the zone management server, from a zone management application operating on the user device, login information for the user;
registering the user device and the user for access to the zone management server; and
identifying camera devices of the plurality of camera devices associated with the user for control by the user device.

20. The non-transitory machine-readable medium of claim 16, wherein the receiving the information defining the zone of interest to the user comprises:
receiving data defining a boundary of the zone of interest, the data defining the boundary corresponding to an outline drawn by the user on a touch screen of the user device.
